(19) United States
(12) Patent Application Publication
(10) Pub. No.: US 2026/0322518 A1
(43) Pub. Date: Oct. 15, 2026

(54) PRECISION TIME SYNCHRONIZATION IN AUTONOMOUS VEHICLES

(71) Applicant: Mobileye Vision Technologies Ltd., Jerusalem (IL)

(72) Inventors: Elad Yacov LEVY, Rishon Le Zion (IL); Elad ROOT, Modiin (IL); Ziv Yakov KFIR, Yavne (IL)

(21) Appl. No.: 19/641,591

(22) Filed: Apr. 8, 2026

(30) Foreign Application Priority Data
Apr. 11, 2025 (DE) 102025114444.3

(51) Int. Cl. H04J 3/06; H04W 84/12

(52) U.S. Cl. CPC H04J 3/0644; H04J 3/0667; H04J 3/0673; H04W 84/12

(57) ABSTRACT

Vehicle clock synchronization mechanisms are disclosed. A first sync is received by an intermediate from a master according to a first protocol. A first time delay is computed based on the first sync. A second sync is received by an endpoint, from the intermediate. A second time delay is then computed based on the second sync, wherein the second time delay is the sum of the first time delay and an endpoint time delay. A third sync is received, by the endpoint from the master, according to a second protocol. A third time delay is computed based on the third sync. A difference is computed between the second time delay and the third time delay. If the difference between the second time delay and the third time delay is outside of a predefined range, a minimal risk maneuver is triggered.

### CROSS-REFERENCE TO RELATED APPLICATIONS

This application claims priority under 35 USC § 119 to German patent application DE 10 2025 114 444.3, filed Apr. 11, 2025, the disclosure of which is incorporated herein by reference in its entirety.

### TECHNICAL FIELD

Various aspects of this disclosure generally relate to precision time synchronization in a computer network, and more specifically methods and systems for vehicle clock synchronization.

### BACKGROUND

As technology continues to advance, fully autonomous vehicles that are capable of navigating on roadways have begun to emerge. Autonomous vehicles may need to take into account a variety of factors and make appropriate decisions based on those factors to safely and accurately reach an intended destination. For example, an autonomous vehicle may need to process and interpret visual information (e.g., information captured from a camera) and may also use information obtained from other sources (e.g., from a GPS device, a speed sensor, an accelerometer, a suspension sensor, etc.). At the same time, in order to navigate to a destination, an autonomous vehicle may also need to identify its location within a particular roadway (e.g., a specific lane within a multi-lane road), navigate alongside other vehicles, avoid obstacles and pedestrians, observe traffic signals and signs, and travel from one road to another road at appropriate intersections or interchanges. Harnessing and interpreting vast volumes of information collected by an autonomous vehicle as the vehicle travels to its destination poses a multitude of design challenges. The sheer quantity of data (e.g., captured image data, map data, GPS data, sensor data, etc.) that an autonomous vehicle may need to analyze, access, and/or store poses challenges that can in fact limit or even adversely affect autonomous navigation. Furthermore, as processing components within an autonomous vehicle transmit vast quantities of sensor data over vehicle networks associated with the autonomous vehicles, it may be important that such processing components have accurately synchronized clocks, so that subsequent operations on vehicle data transmitted over the vehicle networks are associated with temporally consistent time stamps. Algorithms used to safely provide autonomous vehicle operation may break down if time-stamped data from various processing components is not generated by and transmitted to other devices with precisely synchronized clocks.

Various Precision Time Protocols have evolved to address the various requirements for precise network clock synchronization. Network Time Protocol (NTP) is a decades-old networking protocol that was initially developed to synchronize system clocks of networked computers. While NTP remains in use, existing implementations are only capable of synchronizing system clocks within tens of milliseconds over the public Internet and within about one millisecond over a local area network in a best-case scenario. Accordingly, NTP time accuracy is limited by its limited precision. GPS time synchronization is more accurate than NTP. However, in some scenarios cost limitations associated with GPS receivers or unavailability of GPS signals limits the practical utility of GPS for precision time synchronization. More recent Precision Time Protocol (PTP) standards such as the family of standards arising out of Institute of Electrical and Electronics Engineers, Inc. (IEEE) 1588 are designed to provide sub-millisecond (or in some cases much better) clock synchronization between networked devices.

As automated driving systems (ADS) evolve, there is a need for precise time synchronization between connected nodes and sensors within an ADS. As such, some parts of the automotive industry are beginning to adopt various PTP standards in the IEEE 1588 family such as 802.1as, which is also called generalized Precision Time Protocol (gPTP) based on an Ethernet physical layer. Ethernet is a generic term for a wired networking technology, which is related the IEEE 802.3 family of standards. Time synchronization based on gPTP solutions depend to a significant extent on an entire Ethernet path, from network node to network node, in a path including intervening Ethernet interconnection devices (such as Ethernet switches, routers, bridges, etc.) through which packets flow. PTP time synchronization that occurs in connection with ADS nodes are also dependent on latency associated with network stack software implementations associated with participating system-on-a-chip (SoC)s implementations that provide computational resources for ADS nodes.

Accordingly, developing Automotive Safety Integrity Level (ASIL)-grade implementations for a PTP clock synchronization protocol would require an ASIL-grade implementation for each associated Ethernet interconnection device and participating SoC for each ADS node. Such a requirement places a high burden on ADS implementations and might not be feasible in some cases because of cost and complexity.

Accordingly, there is a need for a safety-compliant high precision clock synchronization implementation that provides precision time synchronization with overall ASIL compliance at the level of a master Ethernet switch, by providing ongoing evidence that sufficiently accurate, end-to end time synchronization is maintained between the master Ethernet switches and each participating network software stack implementation (for each SoC) that is directly or indirectly connected to the master Ethernet switch, allowing an ASIL-compliant implementation to reside solely in the master node.

### SUMMARY

Embodiments consistent with the present disclosure provide methods and systems for quantifying safety-related time synchronization deviations between a plurality of components in an autonomous vehicle. The disclosed embodiments may use Ethernet interconnect devices to provide time synchronization features. For example, consistent with the disclosed embodiments, the disclosed systems may employ hardware-or software-based precision time protocol mechanisms for time synchronization to facilitate generation of a navigational responses based on, for example, a time-synchronized analysis of images captured by one or more of cameras. The navigational response may also take into account other data including, for example, global positioning system (GPS) data, sensor data (e.g., from an accelerometer, a speed sensor, a suspension sensor, etc.), and/or other map data. In particular, a master time clock may be based on GPS time synchronization.

In an embodiment, a method is provided for vehicle clock synchronization comprising: receiving, by an intermediate time receiver, from a master time transmitter, according to a first protocol, a first synchronization transmission to synchronize an intermediate internal clock of the intermediate time receiver, computing a first time delay based on the first synchronization transmission, wherein the first time delay is a time delay between the master time transmitter and the intermediate time receiver, receiving, by an endpoint time receiver, from the intermediate time receiver, according to the first protocol, a second synchronization transmission to synchronize an endpoint internal clock of the endpoint time receiver, computing a second time delay based on the second synchronization transmission, wherein the second time delay is the sum of the first time delay and an endpoint time delay between the intermediate time receiver and the endpoint time receiver, receiving, by the endpoint time receiver, from the master time transmitter, according to a second protocol a third synchronization transmission to synchronize the endpoint internal clock of the endpoint time receiver, computing a third time delay based on the third synchronization transmission, wherein the third time delay is an end-to-end time delay between the master time receiver and the endpoint time receiver, computing a difference between the second time delay and the third time delay, and triggering a minimal risk maneuver if the difference between the second time delay and the third time delay is outside of a predefined range.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 shows a block diagram representation of an exemplary autonomous vehicle system in accordance with various aspects of the present disclosure;

FIG. 2 shows a diagrammatic side view representation of an exemplary vehicle including a system consistent with the present disclosure;

FIG. 3 shows an exemplary timing diagram for vehicle clock synchronization in accordance with various aspects of the present disclosure; and

FIG. 4 shows an exemplary flow diagram corresponding to methods for vehicle clock synchronization with various aspects of the present disclosure.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration.” Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

### Autonomous Vehicle Overview

As used throughout this disclosure, the term “autonomous vehicle” refers to a vehicle capable of implementing at least one navigational change without driver input. A “navigational change” refers to a change in one or more of steering, braking, or acceleration of the vehicle. To be autonomous, a vehicle need not be fully automatic (e.g., fully operational without a driver or without driver input). Rather, an autonomous vehicle includes those that can operate under driver control during certain time periods and without driver control during other time periods. Autonomous vehicles may also include vehicles that control only some aspects of vehicle navigation, such as steering (e.g., to maintain a vehicle course between vehicle lane constraints), but may leave other aspects to the driver (e.g., braking). In some cases, autonomous vehicles may handle some or all aspects of braking, speed control, and/or steering of the vehicle.

As human drivers typically rely on visual cues and observations order to control a vehicle, transportation infrastructures are built accordingly, with lane markings, traffic signs, and traffic lights—all designed to provide visual information to drivers. In view of these design characteristics of transportation infrastructures, an autonomous vehicle may include a camera and a processing unit that analyzes visual information captured from the environment of the vehicle. The visual information may include, for example, components of the transportation infrastructure (e.g., lane markings, traffic signs, traffic lights, etc.) that are observable by drivers and other obstacles (e.g., other vehicles, pedestrians, debris, etc.). Additionally, an autonomous vehicle may also use stored information, such as information that provides a model of the vehicle's environment when navigating. For example, the vehicle may use GPS data, sensor data (e.g., from an accelerometer, a speed sensor, a suspension sensor, etc.), and/or other map data to provide information related to its environment while the vehicle is traveling, and the vehicle (as well as other vehicles) may use the information to localize itself on the model.

In some embodiments in this disclosure, an autonomous vehicle may use information obtained while navigating (e.g., from a camera, GPS device, an accelerometer, a speed sensor, a suspension sensor, etc.). In other embodiments, an autonomous vehicle may use information obtained from past navigations by the vehicle (or by other vehicles) while navigating. In yet other embodiments, an autonomous vehicle may use a combination of information obtained while navigating and information obtained from past navigations.

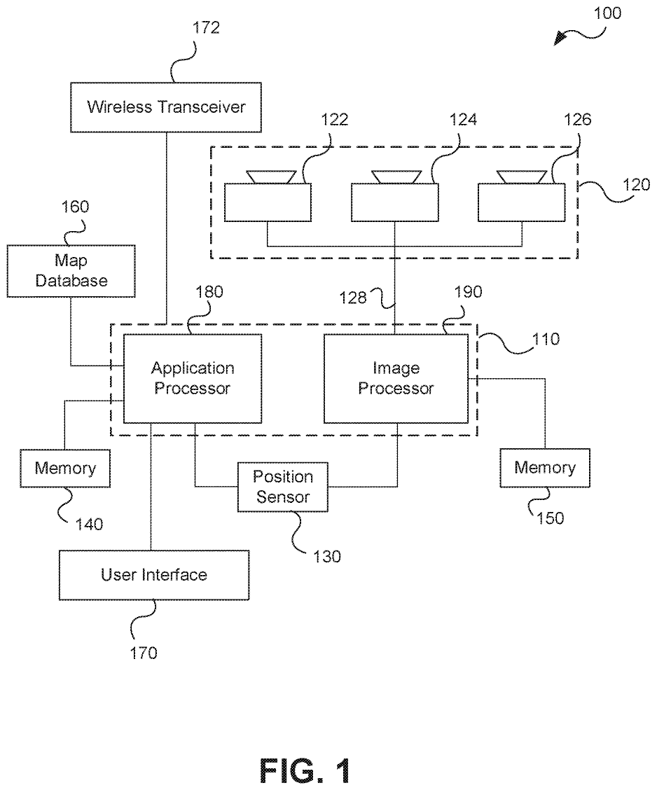

FIG. 1 shows a block diagram representation of an exemplary autonomous vehicle system 100 in accordance with various aspects of the present disclosure. System 100 may include various components depending on the requirements of a particular implementation. In some embodiments, system 100 may include a processing unit 110, an image acquisition unit 120, a position sensor 130, one or more memory units 140, 150, a map database 160, a user interface 170, and a wireless transceiver 172. Processing unit 110 may include one or more processing devices. In some embodiments, processing unit 110 may include an applications processor 180, an image processor 190, or any other suitable processing device. Similarly, image acquisition unit 120 may include any number of image acquisition devices and components depending on the requirements of a particular application. In some embodiments, image acquisition unit 120 may include one or more image capture devices (e.g., cameras), such as image capture device 122, image capture device 124, and image capture device 126. System 100 may also include a data interface 128 communicatively connecting processing device 110 to image acquisition device 120. For example, data interface 128 may include any wired and/or wireless link or links for transmitting image data acquired by image acquisition device 120 to processing unit 110.

Wireless transceiver 172 may include one or more devices configured to exchange transmissions over an air interface to one or more networks (e.g., cellular, the Internet, etc.) by use of a radio frequency, infrared frequency, magnetic field, and/or an electric field. Wireless transceiver 172 may use any known standard to transmit and/or receive data (e.g., Wi-Fi, Bluetooth®, Bluetooth Smart, 802.15.4, ZigBee, etc.). Such transmissions can include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 180 and image processor 190 may include various types of processing devices. For example, either or both of applications processor 180 and image processor 190 may include a microprocessor, preprocessors (such as an image preprocessor), a graphics processing unit (GPU), a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, etc. Various processing devices may be used, including, for example, processors available from manufacturers such as Intel®, AMD®, etc., or GPUs available from manufacturers such as NVIDIA®, ATI®, etc. and may include various architectures (e.g., x86 processor, ARM®, etc.)

In some embodiments, applications processor 180 and/or image processor 190 may include any of the EyeQ™ series of processor chips available from Mobileye®. These processor designs each include multiple processing units with local memory and instruction sets. Such processors may include video inputs for receiving image data from multiple image sensors and may also include video out capabilities. In one example, the EyeQ2® uses 90 nm-micron technology operating at 332 Mhz. The EyeQ2® architecture consists of two floating point, hyper-thread 32-bit RISC CPUs (MIPS32® K® cores), five Vision Computing Engines (VCE), three Vector Microcode Processors (VMP®), Denali 64-bit Mobile DDR Controller, 128-bit internal Sonics Interconnect, dual 16-bit Video input and 18-bit Video output controllers, 16 channels DMA and several peripherals. The MIPS34K CPU manages the five VCEs, three VMP™ and the DMA, the second MIPS34K CPU and the multi-channel DMA as well as the other peripherals. The five VCEs, three VMP® and the MIPS34K CPU can perform intensive vision computations required by multi-function bundle applications. In another example, the EyeQ3®, which is a third-generation processor and is six times more powerful that the EyeQ2®, may be used in the disclosed embodiments. In other examples, the EyeQ4® and/or the EyeQ5@ may be used in the disclosed embodiments. Of course, any newer or future EyeQ™ processing devices may also be used together with the disclosed embodiments.

Any of the processing devices disclosed herein may be configured to perform certain functions. Configuring a processing device, such as any of the described EyeQ™ processors or other controller or microprocessor, to perform certain functions may include programming of computer executable instructions and making those instructions available to the processing device for execution during operation of the processing device. In some embodiments, configuring a processing device may include programming the processing device directly with architectural instructions. For example, processing devices such as field-programmable gate arrays (FPGAs), application-specific integrated circuits (ASICs), and the like may be configured using, for example, one or more hardware description languages (HDLs).

In other embodiments, configuring a processing device may include storing executable instructions on a memory that is accessible to the processing device during operation. For example, the processing device may access the memory to obtain and execute the stored instructions during operation. In either case, the processing device configured to perform sensing, image analysis, and/or navigational functions disclosed herein represents a specialized hardware-based system in control of multiple hardware-based components of a host vehicle.

While FIG. 1 depicts two separate processing devices included in processing unit 110, more or fewer processing devices may be used. For example, in some embodiments, a single processing device may be used to accomplish the tasks of applications processor 180 and image processor 190. In other embodiments, these tasks may be performed by more than two processing devices. Further, in some embodiments, system 100 may include one or more of processing unit 110 without including other components, such as image acquisition unit 120.

Processing unit 110 may comprise various types of devices. For example, processing unit 110 may include various devices, such as a controller, an image preprocessor, a central processing unit (CPU), a graphics processing unit (GPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The GPU may also comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random-access memories, read only memories, flash memories, disk drives, optical storage, tape storage, removable storage and other types of storage. In one instance, the memory may be separate from the processing unit 110. In another instance, the memory may be integrated into the processing unit 110.

Each memory 140, 150 may include software instructions that when executed by a processor (e.g., applications processor 180 and/or image processor 190), may control operation of various aspects of system 100. These memory units may include various databases and image processing software, as well as a trained system, such as a neural network, or a deep neural network, for example. The memory units may include random access memory (RAM), read only memory (ROM), flash memory, disk drives, optical storage, tape storage, removable storage and/or any other types of storage. In some embodiments, memory units 140, 150 may be separate from the applications processor 180 and/or image processor 190. In other embodiments, these memory units may be integrated into applications processor 180 and/or image processor 190.

Position sensor 130 may include any type of device suitable for determining a location associated with at least one component of system 100. In some embodiments, position sensor 130 may include a GPS receiver. Such receivers can determine a user position and velocity by processing signals broadcasted by global positioning system satellites. Position information from position sensor 130 may be made available to applications processor 180 and/or image processor 190. Position sensor 130 may also acquire a highly-accurate clock setting.

In some embodiments, system 100 may include components such as a speed sensor (e.g., a tachometer, a speedometer) for measuring a speed of vehicle 200 and/or an accelerometer (either single axis or multi-axis) for measuring acceleration of vehicle 200.

User interface 170 may include any device suitable for providing information to or for receiving inputs from one or more users of system 100. In some embodiments, user interface 170 may include user input devices, including, for example, a touchscreen, microphone, keyboard, pointer devices, track wheels, cameras, knobs, buttons, etc. With such input devices, a user may be able to provide information inputs or commands to system 100 by typing instructions or information, providing voice commands, selecting menu options on a screen using buttons, pointers, or eye-tracking capabilities, or through any other suitable techniques for communicating information to system 100.

User interface 170 may be equipped with one or more processing devices configured to provide and receive information to or from a user and process that information for use by, for example, applications processor 180. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 170 may include a display, speaker, tactile device, and/or any other devices for providing output information to a user.

Map database 160 may include any type of database for storing map data useful to system 100. In some embodiments, map database 160 may include data relating to the position, in a reference coordinate system, of various items, including roads, water features, geographic features, businesses, points of interest, restaurants, gas stations, etc. Map database 160 may store not only the locations of such items, but also descriptors relating to those items, including, for example, names associated with any of the stored features. In some embodiments, map database 160 may be physically located with other components of system 100. Alternatively or additionally, map database 160 or a portion thereof may be located remotely with respect to other components of system 100 (e.g., processing unit 110). In such embodiments, information from map database 160 may be downloaded over a wired or wireless data connection to a network (e.g., over a cellular network and/or the Internet, etc.). In some cases, map database 160 may store a sparse data model including polynomial representations of certain road features (e.g., lane markings) or target trajectories for the host vehicle.

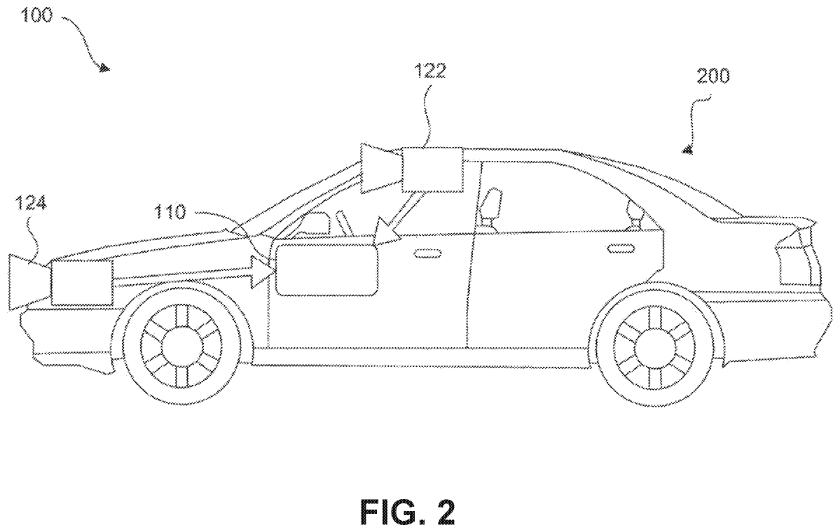

FIG. 2 shows a diagrammatic side view representation of an exemplary vehicle including a system consistent with the present disclosure. System 100, or various components thereof, may be incorporated into various different platforms. In some embodiments, system 100 may be included on a vehicle 200, as shown in FIG. 2. For example, vehicle 200 may be equipped with a processing unit 110 and any of the other components of system 100, as described above relative to FIG. 1. While in some embodiments vehicle 200 may be equipped with only a single image capture device (e.g., camera), in other embodiments, multiple image capture devices may be used. For example, either of image capture devices 122 and 124 of vehicle 200, as shown in FIG. 2, may be part of an ADAS (Advanced Driver Assistance Systems) imaging set.

The image capture devices included on vehicle 200 as part of the image acquisition unit 120 may be positioned at any suitable location. In some embodiments, as shown in FIG. 2, image capture device 122 may be located in the vicinity of the rearview mirror. This position may provide a line of sight similar to that of the driver of vehicle 200, which may aid in determining what is and is not visible to the driver. Image capture device 122 may be positioned at any location near the rearview mirror, but placing image capture device 122 on the driver side of the mirror may further aid in obtaining images representative of the driver's field of view and/or line of sight. In addition to image capture devices, vehicle 200 may include various other components of system 100. For example, processing unit 110 may be included on vehicle 200 either integrated with or separate from an engine control unit (ECU) of the vehicle. Vehicle 200 may also be equipped with a position sensor 130, such as a GPS receiver and may also include a map database 160 and memory units 140 and 150.

Wireless transceiver 172 may transmit and/or receive data over one or more networks (e.g., cellular networks, the Internet, etc.). For example, wireless transceiver 172 may upload data collected by system 100 to one or more servers, and download data from the one or more servers. Via wireless transceiver 172, system 100 may receive, for example, periodic or on demand updates to data stored in map database 160, memory 140, and/or memory 150. Similarly, wireless transceiver 172 may upload any data (e.g., images captured by image acquisition unit 120, data received by position sensor 130 or other sensors, vehicle control systems, etc.) from by system 100 and/or any data processed by processing unit 110 to the one or more servers. System 100 may upload data to a server (e.g., to the cloud) based on a privacy level setting. For example, system 100 may implement privacy level settings to regulate or limit the types of data (including metadata) sent to the server that may uniquely identify a vehicle and or driver/owner of a vehicle. Such settings may be set by user via, for example, wireless transceiver 172, be initialized by factory default settings, or by data received by wireless transceiver 172.

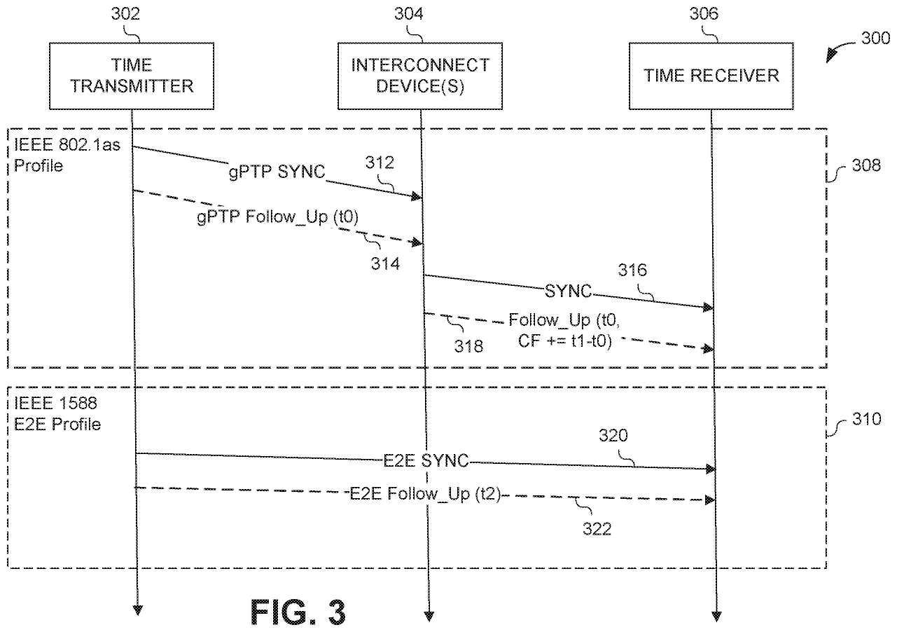

FIG. 3 shows an exemplary timing diagram 300 for vehicle clock synchronization in accordance with various aspects of the present disclosure. Time transmitter 302 transmits messages to other devices in a network to cause the other devices'system clocks to become synchronized with system clocks contained within time transmitter 302. Time transmitter may also be referred to as a “master time transmitter.” In some embodiments, time transmitter 302 may itself periodically receive external time synchronization from, for example, a GPS signal or another external time synchronization data source. In the context of IEEE 802.1as (gPTP) time transmitter 302 may be designated “grandmaster.” In some embodiments, a particular node may be designated by virtue of ADS architecture to be a “grandmaster” time transmitter. Optionally, various standard “election” mechanisms may be employed to determine, in the field, which one of a plurality of ADS nodes should be designated as time transmitter 302 (grandmaster).

As illustrated in connection with timing diagram 300, time transmitter 302 may transmit various PTP-related instructions to synchronize time in various devices in a network, such as an ADS network. As shown in connection with synchronization transmission 312, a gPTP SYNC message is sent from time transmitter 302 to at least one interconnect device 304. Interconnect device 304 may be referred to as an “intermediate time receiver.” Follow-up transmission 314 is shown as a dashed line from time transmitter 302 to interconnect device 304, because under PTP protocols a sufficiently fast and repeatable Ethernet data connection permits a so-called one-step synchronization, in which time transmitter 302 inserts a current time stamp directly into synchronization transmission 312. One-step, hardware gPTP sync operations are convenient and precise, but they typically require non-congested Ethernet connections and can potentially lose precision if one-step synchronizations are attempted in congested networks or networks in which collisions or overloaded switches cause unexpected delays in packet transmissions.

Accordingly, gPTP follow-up mechanisms may be employed to synchronize clocks when delays associated with congested networks or in the case of software clock synchronization schemes that rely on a software implementation of a network stack to receive a time stamp over a network. In such embodiments, synchronization transmission 312 and follow-up transmission 314 are used to calculate a mean time delay between network nodes. As shown in timing diagram 300, example subsequent transmissions such as synchronization transmission 316 and follow-up transmission 318 function similarly to synchronization transmission 312 and follow-up transmission 314 to pass along time synchronization indirectly from time transmitter through at least one interconnect device 304 finally to time receiver node 306. Time receiver node 306 may also be referred to as an “endpoint time receiver.” An endpoint time receiver may be, for example, an autonomous vehicle component for capturing and processing vehicle sensor data and/or for controlling or interfacing a vehicle. An endpoint time receiver may also be an intermediate time receiver to the extent an intermediate time receiver may need a synchronized clock for further downstream time synchronization. Time receiver node 306 ultimately can calculate a current time based on time synchronization information provided in connection with follow-up transmission 318. In this embodiment a Correction Field (CF) may be computed according to one or more formulas defined by the IEEE 802.1as.

A single interconnect device 304 is depicted in FIG. 3, however consistent with the present teachings, any number of interconnect devices may be present to deliver packets over a network associated with an autonomous vehicle as shown. For example, in case there were two interconnect devices 304, timer transmitter would first synchronize its clock with a first interconnect device. Then the first interconnect device would synchronize its clock with a subsequent downstream interconnect device, which would then synchronize its clock with time receiver 306. Such a downstream clock synchronization process may proceed with an arbitrarily large number of interconnect devices 304.

Such an indirect path for time synchronization may be applied over a network in an ADS that is also being used to transmit sensor data such as video between nodes in the ADS. The period between independent time synchronizations may be selected based on empirical measurements of time drift as observed in connection with time receiver node 306 over the course of precision time synchronization using a step-wise protocol such as step-wise protocol 308. It is understood that a larger sample size of computed transmission time delays will result in a smoother mean propagation time measurement, so it may be desirable to go through a full path of synchronization and follow up measurements to achieve a stable mean value of the intrinsic delay in a particular network path. There is also a tradeoff in network traffic on a network that is ideally used primarily for transmitting substantive sensor data. Moreover, it is possible that gPTP time synchronization as explained above may lose precision and therefore accuracy due to a number of factors including network congestion and/or software overload of software network stack implementations associated with interconnect device 304 and/or time receiver node 306. Should time transmitter 302 and time receiver 306 become sufficiently out of sync that ADS functionality may begin to degrade, such a lack of synchronization may become a safety issue for the ADS, requiring the triggering of a Minimal Risk Maneuver (MRM).

In connection with timing diagram 300, the present disclosure provides a mechanism to periodically double-check a gPTP step-wise time clock synchronization provided by step-wise protocol 308. The present disclosure provides an end-to-end protocol, whereby time transmitter “directly” synchronizes its time clock with time receiver 306. In some embodiments, this may be carried out periodically to compute an associated inter-protocol delay difference. Such a difference may represent a deviation in an amount of delay as measured in connection with step-wise protocol 308 and end-to-end protocol 310. In practice, step-wise protocol 308 is less resource intensive and as such is less intrusive to regular ADS operation, however, to the extent an ADS can tolerate a periodic time synchronization confirmation (by ascertaining the above difference) the more resource intensive end-to-end sync can be employed at a configurable period to perform a safety check on the step-wise protocol. As set forth above in connection with synchronization transmission 312, should hardware conditions allow, end-to-end transmission 320 may be employed directly without using follow up transmission 322. A time synchronization in connection with end-to-end protocol 310 will be most accurate when interconnect devices, such as interconnect device 304, forwards packets from time transmitter as quickly and transparently as possible. In some embodiments, this involves receiving at interconnect device 304 a packet containing time synchronization data associated with end-to-end protocol 310. When interconnect device 304 identifies such a packet, it will increase the priority of such a packet over substantially all other packets that are being processed. As such this may involve slowing down or even dropping other packets (if necessary) which packet streams will recover using retry mechanisms, etc. However, since interconnect device 304 prioritizes packets associated with end-to-end time synchronization transmission 320 and end-to-end follow-up transmission 322, a fast and stable end-to-end time synchronization may be achieved in order to confirm that the step-wise protocol provides a sufficiently accurate time synchronization.

In some embodiments, a master time transmitter as embodied in software running on a SoC may distribute its time using an end-to-end messaging protocol using Synchronize (SYNC) and Follow-up (FUP) messages which include a transmission timestamp associated with a SYNC packet. In some embodiments which utilize FUP messages, a timestamp may be omitted from the SYNC message as a relevant time stamp is provided in the FUP message. In some embodiments, a boundary clock mechanism, e.g., using a linux PHC2SYS, which is a program that synchronizes two clocks and may be used to distribute clock values received over gPTP(802.1as) to the E2E protocol. In these embodiments other SoCs in the platform may capture the PTP E2E SYNC and FUP packets with hardware timestamps using, for example, unicast, multicast, or broadcast messages from a master time transmitter.

In some such embodiments, a hardware time synchronization process may employ a secondary or parallel interface (if available) which may be less loaded, and hence could result in reduced latency to reduce congestion with other traffic and improve time synchronization accuracy. In some embodiments, such a secondary interface may be provided in the form of an independent Ethernet path. In this case, all receiving SoCs may compare an end-to-end hardware time synchronization time stamp (E2E_Sync_HW_Timestamp) to an end-to-end follow-up published time (E2E_FUP_published_time) which is designated t2 in connection with end-to-end transmission 322 in FIG. 3.

Any clock difference over a certain threshold such as, for example, over 200 microseconds (or 100 microseconds) may be handled as a safety issue, resulting in a possible notification of a driver or triggering an MRM. Such a threshold may be selected in the 100 to 200 microsecond range based on a product Fault Tolerance Time Interval (FTTI) and the impact of such clock error on an automated driving system's ability to continue running driving applications such as Highway Pilot, Handwheel Actuator, etc., during a particular product FTTI period, although it is noted that the use of an exemplary range of 100 to 200 milliseconds herein is offered for demonstrative purposes and should not be understood as limiting; other thresholds outside of this range are possible and will be selected based upon the needs of a given implementation. In practice a clock difference may be positive or negative, i.e., a clock may be ahead of or behind a master clock. Therefore, a clock difference may be outside of or within a range of clock differences. Accordingly, when the absolute value of a clock difference exceeds a threshold, it can be said to lie “outside of a predefined range” of clock differences. In some embodiments, all time receivers run a single PTP protocol instance or use an alternative clock time synchronism loop mechanism. In these embodiments, intermediate Ethernet switches directly relay packets associated with an end-to-end protocol, whether or not the end-to-end protocol is employing a hardware (one-step SYNC) or a software-based (SYNC, and FUP) time synchronization approach. In these embodiments, whether they employ hardware and/or software clocks, a corresponding endpoint clock is synchronized to a time domain that may be certified to ASIL-B. Latency of end-to-end messages may be reduced by elevating corresponding Ethernet packets to a high switch priority used only for those packets associated with messages for end-to-end clock synchronization. In some cases, this may result in latencies that are less than 50 microseconds and may be achieved for certain endpoint devices such as EyeQ2® as well as other EyeQ™ devices up to the EyeQ5® connected to an Ethernet switch interconnected with 10 Gigabit Ethernet links. In some embodiments, an uncongested physical ethernet interface is used for the receive path thereby further improving performance.

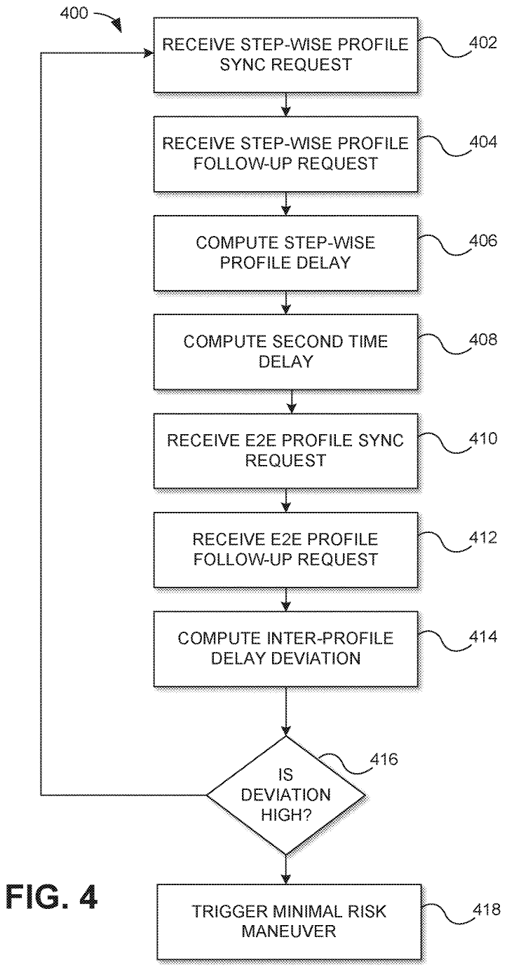

FIG. 4 shows an exemplary flow diagram 400 corresponding to methods for vehicle clock synchronization in accordance with various aspects of the present disclosure. At step 402, a first synchronization request is received from a master time transmitter. In some embodiments, the first synchronization request may be a hardware or software PTP synchronization transmission. Such a transmission may be in the form of a single Ethernet packet, and such packet may be directed to a single IP address (unicast) or be provided in connection with a multicast or a broadcast packet. In some embodiments, a step-wise synchronization instruction is received by an intermediate time receiver, such as an Ethernet switch to synchronize an intermediate time-receiver internal clock. In some embodiments, there is only one intermediate time receiver such as an Ethernet switch. In other embodiments, a plurality of intermediate time receivers may exist in a path from a master time transmitter to an endpoint time receiver. In the case of multiple intermediate time receivers, multiple instances of a synchronization between a time transmitter and a time receiver may occur as described above in more detail in connection with FIG. 3.

Optionally, a follow up transmission may be used in addition to the SYNC request at step 402. In some embodiments, an intermediate follow-up transmission is received by the intermediate time receiver regarding intermediate time synchronization; wherein the computing the second time delay comprises computing the second time delay based on the second synchronization transmission and the intermediate follow-up transmission.

At step 404, a first time delay may be calculated. In the case of a one-step hardware SYNC message, a master time transmitter inserts a timestamp into the contents of an Ethernet packet prior to transmission. In some embodiments, User Datagram Protocol (UDP) is used to encapsulate packets sent to provide associated SYNC transmissions. In these embodiments, relevant time stamps are inserted into a UDP payload. The downstream time receiver (or receivers in the case of multicast or broadcast) to which the master time transmitter has directed a SYNC message can simply extract the time stamp from the received SYNC message. In the optional use case of employing follow-up messages, a master time transmitter may omit a time stamp from the SYNC message and include a time stamp into the FUP message instead. In this case, the propagation delay from master time transmitter to the intermediate device may be calculated according to the PTP protocol being employed.

Next, a second SYNC message is transmitted from an intermediate device to an endpoint. Accordingly, at step 406, an endpoint time receiver receives a second SYNC message from the intermediate time receiver according to the first protocol, by way of a second synchronization transmission to synchronize an endpoint internal clock of the endpoint time receiver. In some embodiments the first protocol is a step-wise time synchronization protocol such as a protocol according to the Institute of Electrical and Electronics Engineers 802.01as. The step-wise time synchronization protocol may additionally employ a follow-up transmission, which contains a time stamp that can be used to calculate a propagation delay between the intermediate time receiver and the endpoint time receiver.

At step 408, a second time delay is calculated. In some embodiments, the second time delay may be based on a second synchronization transmission, wherein the second time delay is the sum of the first time delay and an endpoint time delay between the intermediate time receiver and the endpoint time receiver. If an optional step-wise time synchronization protocol is employed, a follow-up transmission will be sent from the intermediate time receiver to the endpoint time receiver, so that the endpoint time receiver may calculate the further propagation delay associated with the transmission of packets from the intermediate time receiver to the endpoint time receiver from a time stamp contained within the follow-up transmission from the intermediate time receiver to the endpoint time receiver.

At step 410, a third synchronization transmission is received by the endpoint time receiver, on an end-to-end basis from the master time transmitter, according to a second protocol to synchronize the endpoint internal clock of the endpoint time receiver. In some embodiments, the second protocol is an end-to-end protocol according to the Institute of Electrical and Electronics Engineers 1588. Beneficially, the third synchronization transmission is sent on an end-to-end basis from the master time transmitter to the endpoint time receiver. Depending on a network topology of the end-to-end network that interconnects the master time transmitter to the endpoint time receiver, the end-to-end network may contain multiple interconnection devices such as the intermediate time receivers discussed in connection with the previous steps. However, in connection with the end-to-end (E2E) protocol that is employed in connection with step 410, the intermediate time receivers do not participate (directly) in a step-wise time synchronization protocol. Rather, the intermediate time receiver act as expeditious interconnect devices by placing a high priority on packets associated with the end-to-end protocol. That is to say that when an intermediate time receiver receives a packet that is destined to the endpoint time receiver, the intermediate time receiver takes appropriate actions to ensure that associated packets are transmitted to their destination (whether directly or indirectly) as quickly as possible. If there is a queue of pending packet transmissions, for example, the intermediate time receiver places the end-to-end relevant packet at or near the head of the queue. As with the other protocols described above, a follow up transmission may be employed in addition to the SYNC transmission. Because of the end-to-end nature of the third SYNC request, a follow-up transmission may be beneficial to compute, for example, a mean propagation delay between a master time transmitter and an endpoint time receiver.

At step 412, a third (E2E) time delay is calculated based upon a time stamp associated with the corresponding SYNC transmission. This would take place, for example, in the event that a one-step-type protocol could be carried out between the master time transmitter and the endpoint time receiver, for example by way of a secondary or out-of-band parallel Ethernet connection. In practice, however there may not be a network connection between the master time transmitter and the endpoint time receiver that would be usable in a one-step PTP time synchronization. In such a case, a follow-up message would be transmitted from the master time transmitter to the endpoint time receiver through a number of interconnects (intermediate time receivers) by way of a network traffic prioritization scheme as described above with respect to the SYNC transmission. That is to say intermediate Ethernet switches (or other network interconnect devices) prioritize network traffic between the master time transmitter and the endpoint time receiver to facilitate the end-to-end time synchronization.

At step 414, a difference between the second time delay and the third or end-to-end time delay is calculated. At test 416, it is determined whether the difference value calculated in the previous step exceeds a predefined threshold. triggering a minimal risk maneuver if the difference between the second time delay and the third time delay is outside of a predefined range.

At test 416, it is determined whether, based on the difference value, certain safety measures should be taken. In some embodiments, such safety measure could include alerting a driver that a time synchronization failure has occurred and that the driver needs to take over. In some embodiments, safety measures could include triggering a minimal risk maneuver, such as entering a minimal risk condition or a stable, stopped state by, for example, safely pulling over to the side of a road. If the threshold is exceeded execution continues to step 418, which takes an appropriate safety action on the basis that clock deviation is sufficiently large to prevent proper operation of the autonomous vehicle. If possible, a driver can be alerted to take over or the vehicle can execute an MRM. If the threshold is not exceeded execution proceeds back to step 402.

While the above descriptions and connected figures may depict components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A method for vehicle clock synchronization comprising:
receiving, by an intermediate time receiver, from a master time transmitter, according to a first protocol, a first synchronization transmission to synchronize an intermediate internal clock of the intermediate time receiver;
computing a first time delay based on the first synchronization transmission, wherein the first time delay is a time delay between the master time transmitter and the intermediate time receiver;
receiving, by an endpoint time receiver, from the intermediate time receiver, according to the first protocol, a second synchronization transmission to synchronize an endpoint internal clock of the endpoint time receiver;
computing a second time delay based on the second synchronization transmission, wherein the second time delay is the sum of the first time delay and an endpoint time delay between the intermediate time receiver and the endpoint time receiver;
receiving, by the endpoint time receiver, from the master time transmitter, according to a second protocol, a third synchronization transmission to synchronize the endpoint internal clock of the endpoint time receiver;
computing a third time delay based on the third synchronization transmission, wherein the third time delay is an end-to-end time delay between the master time transmitter and the endpoint time receiver;
computing a difference between the second time delay and the third time delay; and
triggering a minimal risk maneuver if the difference between the second time delay and the third time delay is outside of a predefined range.

2. The method of claim 1, wherein the first protocol is a step-wise time synchronization protocol.

3. The method of claim 2, wherein the first protocol is a protocol according to Institute of Electrical and Electronics Engineers 802.1AS.

4. The method of claim 1, wherein the second protocol is an end-to-end time synchronization protocol.

5. The method of claim 4, wherein the second protocol is a protocol according to the Institute of Electrical and Electronics Engineers 1588.

6. The method of claim 1, further comprising receiving from the master time transmitter by the intermediate time receiver, a second intermediate follow-up transmission regarding intermediate time synchronization; wherein the computing the second time delay comprises computing the second time delay based on the second synchronization transmission and the intermediate follow-up transmission.

7. The method of claim 1, further comprising receiving from the time transmitter by the endpoint time receiver, an end-to-end follow-up transmission regarding end-to-end time synchronization, wherein the computing the third time delay comprises computing the third time delay based on the third synchronization transmission and the end-to-end follow-up transmission.

8. At least one non-transitory computer-readable storage medium storing instructions that, when executed by at least one processor, cause the at least one processor to perform a method for vehicle clock synchronization, the method comprising:
receiving, by an intermediate time receiver, from a master time transmitter, according to a first protocol, a first synchronization transmission to synchronize an intermediate internal clock of the intermediate time receiver;
computing a first time delay based on the first synchronization transmission, wherein the first time delay is a time delay between the master time transmitter and the intermediate time receiver;
receiving, by an endpoint time receiver, from the intermediate time receiver, according to the first protocol, a second synchronization transmission to synchronize an endpoint internal clock of the endpoint time receiver;
computing a second time delay based on the second synchronization transmission, wherein the second time delay is the sum of the first time delay and an endpoint time delay between the intermediate time receiver and the endpoint time receiver;
receiving, by the endpoint time receiver, from the master time transmitter, according to a second protocol, a third synchronization transmission to synchronize the endpoint internal clock of the endpoint time receiver;
computing a third time delay based on the third synchronization transmission, wherein the third time delay is an end-to-end time delay between the master time transmitter and the endpoint time receiver;
computing a difference between the second time delay and the third time delay; and
triggering a minimal risk maneuver if the difference between the second time delay and the third time delay is outside of a predefined range.

9. The non-transitory computer-readable storage medium of claim 8, wherein the first protocol is a step-wise time synchronization protocol.

10. The non-transitory computer-readable storage medium of claim 8, wherein the second protocol is an end-to-end time synchronization protocol.

11. The non-transitory computer-readable storage medium of claim 10, wherein the second protocol is a protocol according to the Institute of Electrical and Electronics Engineers 1588.

12. The non-transitory computer-readable storage medium of claim 8, wherein the method further comprises receiving from the master time transmitter by the intermediate time receiver, a second intermediate follow-up transmission regarding intermediate time synchronization; wherein the computing the second time delay comprises computing the second time delay based on the second synchronization transmission and the intermediate follow-up transmission.

13. The non-transitory computer-readable storage medium of claim 8, wherein the method further comprises receiving from the time transmitter by the endpoint time receiver, an end-to-end follow-up transmission regarding end-to-end time synchronization, wherein the computing the third time delay comprises computing the third time delay based on the third synchronization transmission and the end-to-end follow-up transmission.

14. A system for vehicle clock synchronization comprising:
a master time transmitter comprising a processor coupled with a memory;
an intermediate time receiver for receiving, from the master time transmitter, according to a first protocol, a first synchronization transmission to synchronize an intermediate internal clock of the intermediate time receiver,
wherein the processor computes a first time delay based on the first synchronization transmission, wherein the first time delay is a time delay between the master time transmitter and the intermediate time receiver;
an endpoint time receiver for receiving, from the intermediate time receiver, according to the first protocol, a second synchronization transmission to synchronize an endpoint internal clock of the endpoint time receiver,
wherein the processor computes a second time delay based on the second synchronization transmission, wherein the second time delay is the sum of the first time delay and an endpoint time delay between the intermediate time receiver and the endpoint time receiver,
wherein the endpoint time receiver receives, from the master time transmitter, according to a second protocol, a third synchronization transmission to synchronize the endpoint internal clock of the endpoint time receiver,
wherein the processor computes a third time delay based on the third synchronization transmission, wherein the third time delay is an end-to-end time delay between the master time transmitter and the endpoint time receiver,
wherein the processor computes a difference between the second time delay and the third time delay, and
wherein the processor triggers a minimal risk maneuver if the difference between the second time delay and the third time delay is outside of a predefined range.

15. The system of claim 14, wherein the first protocol is a step-wise time synchronization protocol.

16. The system of claim 15, wherein the first protocol is a protocol according to Institute of Electrical and Electronics Engineers 802.1AS.

17. The system of claim 14, wherein the second protocol is an end-to-end time synchronization protocol.

18. The system of claim 17, wherein the second protocol is a protocol according to the Institute of Electrical and Electronics Engineers 1588.

19. The system of claim 14, wherein the master time transmitter transmits to the intermediate time receiver, a second intermediate follow-up transmission regarding intermediate time synchronization, wherein computing the second time delay comprises computing the second time delay based on the second synchronization transmission and the intermediate follow-up transmission.

20. The system of claim 14, wherein the time transmitter transmits to the endpoint time receiver, an end-to-end follow-up transmission regarding end-to-end time synchronization, wherein computing the third time delay comprises computing the third time delay based on the third synchronization transmission and the end-to-end follow-up transmission.
